(19) United States
(12) Patent Application Publication
(10) Pub. No.: US 2010/0200180 A1
(43) Pub. Date: Aug. 12, 2010

(54) FAST INSTALLABLE AND DETACHABLE AUTOMOBILE SNOW COVER HAVING TWO PENDENT SELF-STRETCHED FLAPS

(76) Inventor: Wen-Cheng LIEN, Kaohsiung City (TW)

Correspondence Address: Muncy, Geissler, Olds & Lowe, PLLC, 4000 Legato Road, Suite 310, FAIRFAX, VA, 22033, US

(21) Appl. No.: 12/369,153

(22) Filed: Feb. 11, 2009

(51) Int. Cl. B60J 11/08

(52) U.S. Cl. 160/370.21

(57) ABSTRACT

The snow cover of the invention has a main shade with fastening elements located at the upper end to be anchored on the car roof and other fastening elements on a lower end to be anchored on the car hood. The snow cover includes two triangular pendent self-stretched flaps each fastens to a pendant to stretch the main shade smoothly to neatly cover the windshield. When car doors are opened, two pendent self-stretched flaps slide quickly inside the car doors due to pendant principle. After the card doors are closed, two pendent self-stretched flaps are clamped by the car doors and the car body and held inside the car body. To move the snow cover, open the car doors, unfasten fastening elements at the upper and lower ends of the main shade, then the snow cover can be removed and stowed.

### FIELD OF THE INVENTION

The present invention relates to a fast installable and detachable automobile snow cover having two pendent self-stretched flaps and particularly to an apparatus disposed on the front windshield and the rear windshield of an automobile to fend off snow and frost from direct accumulating on the windshields when not driving.

### BACKGROUND OF THE INVENTION

Automobiles parking outdoors in a snowy winter season often have their windshields covered by snow and frost. Driver's vision is affected and removing the snow and frost is troublesome. To remedy this problem, referring to FIG. 1, China patent No. CN2827765 discloses a protective cover 10 which has a shade 11 formed at a size mating the windshield. The shade 11 has two outer sides attached to fastening straps 12 and also has the periphery attached to magnets 13. The number of the magnets 13 is eight or more to attach the upper and lower edges of the windshield and the windshield pillars at two sides. After the magnets 13 are anchored, the fastening straps 12 at the two sides are fastened to the rearview mirrors of the automobile. Such a structure has drawbacks in use, notably:

1. Installation and removing are difficult: As the protective cover is anchored on the vehicle body through more than eight magnets fastened to the periphery of the shade, anchoring the magnets on the vehicle body by magnetic attraction could encounter problems. After installation, adjusting the magnets at desirable positions has to be done to smooth the shade. To prevent the shade from dropping and lost, the fastening straps have to be fastened to the rearview mirrors. Installation is tedious.

2. Lost problem: As the protective cover is anchored through the magnets and fastening straps that are exposed outside the vehicle body, it can be easily removed and taken away by illegitimated persons by unfastening the fastening straps from the rearview mirrors and removing the magnets.

3. Dropping problem: In the event that strong wind takes place during snowing and the fastening straps have not been fastened securely, the protective cover is easily blown away by the wind.

4. Limited protection range: As the shade is formed at a size mating the vehicle body, applicable vehicle types are limited. Moreover, the shade periphery has to attach to metal sides of the vehicle body, the covered protective area cannot be sufficiently expanded. In the event of strong wind and snowing conditions, the snow and frost could easily enter the windshield locations.

FIG. 2 illustrates U.S. Pat. No. 5,615,923 which provides a cover for vehicle window. It has a windshield cover 10A with a shade 11A which has four corners attached to nylon hook fasteners 11A (Velcro hook strips). The windshield 12A has nylon hook fasteners 121A (Velcro hook strips) attached thereon corresponding to the nylon hook fasteners 111A for bonding together. The shade 11A also is stitched to a strap 13A at a desired location that has a tail end fastened to a buckle 131A. The shade 11A is formed at a size to cover merely the windshield 12A without covering the surrounding area of the windshield 12A. Moreover, the strap 13A is drawn by the buckle 131A through a downward force in one direction when the car door is closed, hence the windshield cover 10A also is drawn by the downward force in one direction as shown in the drawing. As a result, an air inlet 14A is formed, and wind and snow can enter through the air inlet 14A. Such a structure also has flaws in use, notably:

1. The windshield is not effectively protected: Like other conventional shades, its covering area is limited to the windshield. As snow often is dropped with strong wind, the surrounding of the windshield cannot effectively prevent wind and snow from entering, and snow protection effect suffers.

2. Not desirable theft-proof effect and little theft-thwarting efficacy: As there is a strap stitched to the shade to fasten to a buckle, and a portion of the strap is exposed outside the windshield. The exposed portion can be easily cut off by malefactors, then the shade can be removed and stitched to another strap to be used again by them. It does not have desired theft-proof effect.

3. The nylon hook fasteners attached to the vehicle body are unsightly: When the windshield cover is not in use, the nylon hook fasteners are still bonded to the windshield. It is not aesthetic appealing.

There are also other snow covers on the market. Aside from the full covering products, on providing optimal protective effect with minimum material and fast automatic stretching and neat covering of the windshield, the conventional snow covers still leave a lot to be desired. The present invention aims to address these issues and provide improvements.

### SUMMARY OF THE INVENTION

The primary object of the present invention is to provide a fast installable and detachable automobile snow cover having two pendent self-stretched flaps that adopts a non-full coverage design and can be installed and removed quickly, prevent dropping and pilferage, and effectively fend off frost and snow from depositing on the windshield.

To achieve the foregoing object, the snow cover of the invention has a main shade with an upper end attached to fastening elements to anchor on a car roof and a lower end also attached to other fastening elements to anchor on a car hood, and two pendent self-stretched flaps at two sides to stretch and smooth the main shade through a swing pendant principle. The pendent self-stretched flaps can slide quickly inside car doors of an automobile during opening. When the car doors are closed, the two pendent self-stretched flaps are hung down inside car doors. For removing, open the car doors, and the main shade can be removed by unfastening the fastening elements at the upper and lower ends.

By means of the construction set forth above, the invention can provide many benefits, notably:

1. Fast installation and removing: The fastening elements at the upper and lower ends of the main shade can be anchored quickly. The two pendent self-stretched flaps can slide into the car behind the car doors when the car doors are opened. Installation is finished when the car doors are closed. For removing, open the car doors, the main shade can be removed by unfastening the fastening elements at the upper and lower ends thereof. Thus installation and removing can be accomplished quickly.

2. Theft-proof and dropping-proof: Each of the pendent self-stretched flaps has a corner fastened to a pendant at a selected size. When the car door is closed, the car door and car body are closed to form a small crevice. The flaps and pendants are confined in the automobile without exposing or losing, thus can prevent pilferage and blowing away by strong wind.

3. More effective protection of the windshield: The main shade has the lower portion wider than the upper portion. The two pendent self-stretched flaps provide stretching forces to the main shade. When the car doors are closed, a shearing force is formed between the car doors and the car body. Thus the main shade is further stretched to form a greater surface tension. It is adaptable to car bodies of different sizes. It also provides a greater protective area. Moreover, the two pendent self-stretched flaps provide enclosure coverage on the windshield, hence can effectively prevent snow and frost from depositing around the windshield. The invention also can be used to cover the rear windshield.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a perspective view of a conventional windshield cover disclosed in China patent No. CN2827765Y.

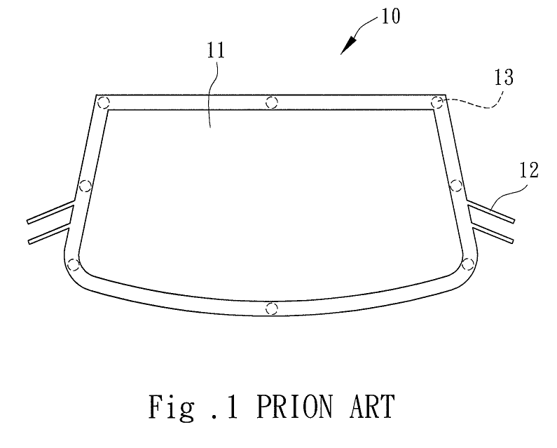

FIG. 2 is a perspective view of another conventional windshield cover disclosed in U.S. Pat. No. 5,615,923.

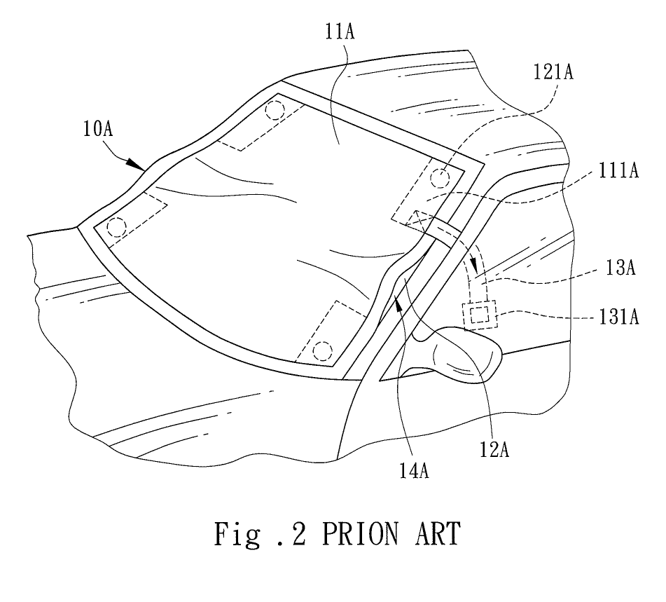

FIG. 3 is a plane view of the present invention.

FIG. 4A is a perspective view of the present invention anchored on a car body and stretched by a pendant.

FIG. 4B is a schematic view of the present invention showing fast installation of the pendent self-stretched flap due to pendant principle.

FIG. 4C is a perspective view of the present invention installed on an automobile.

FIG. 5 is a plane view of another embodiment of the present invention.

FIG. 6 is a schematic view of the present invention showing the mechanics principle of the pendent self-stretched flap and the pendant.

FIG. 7 is a schematic view of the present invention showing the pendent self-stretched flap in a stretched condition.

FIG. 8 is a schematic view of the present invention showing the main shade and the pendent self-stretched flap in a coupling condition.

### DETAILED DESCRIPTION OF THE PREFERRED EMBODIMENTS

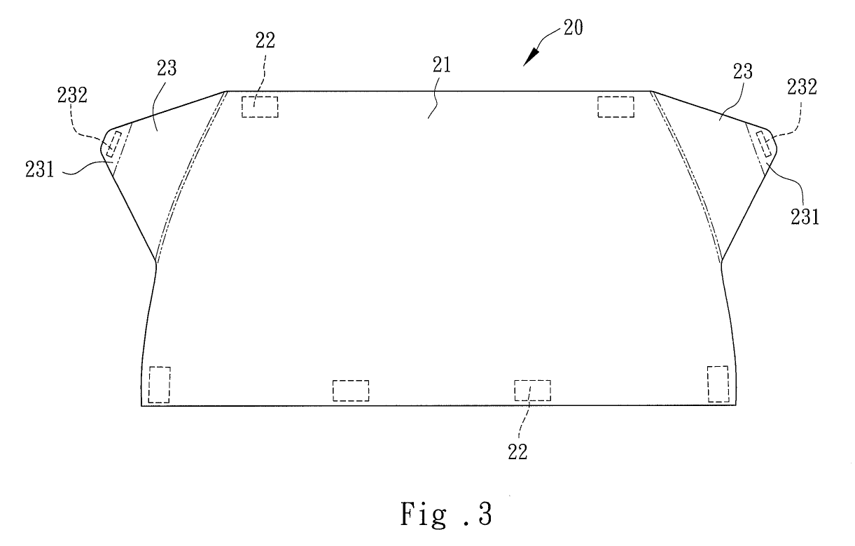

Please refer to FIG. 3 for an embodiment of the fast installable and detachable automobile snow cover having two pendent self-stretched flaps. It includes a snow cover 20 which has a main shade 21 formed with a narrower upper side and a wider lower side, and having an upper end and lower end attached respectively to a plurality of fastening elements 22. The fastening elements 22 may be magnetic slats or suction cups. The main shade 21 further has pendent self-stretched flaps 23 fastened respectively to a left side and a right side at the upper portion. Each pendent self-stretched flap 23 has a corner 231 attached to a pendant 232.

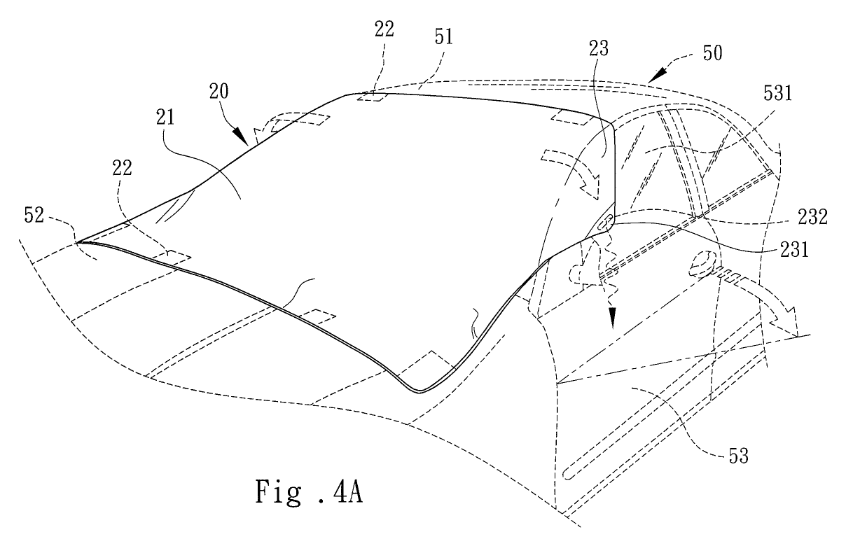

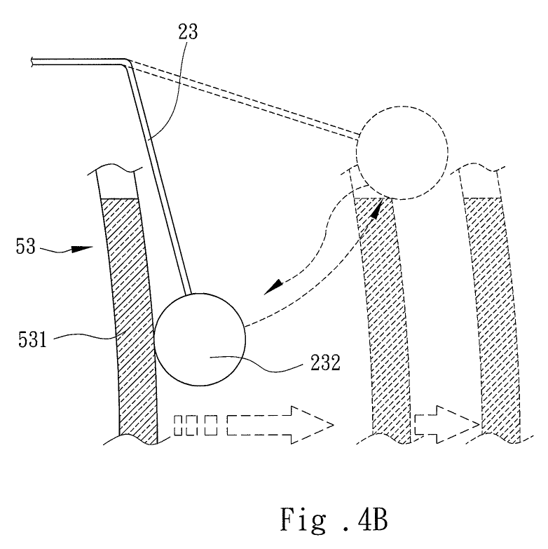

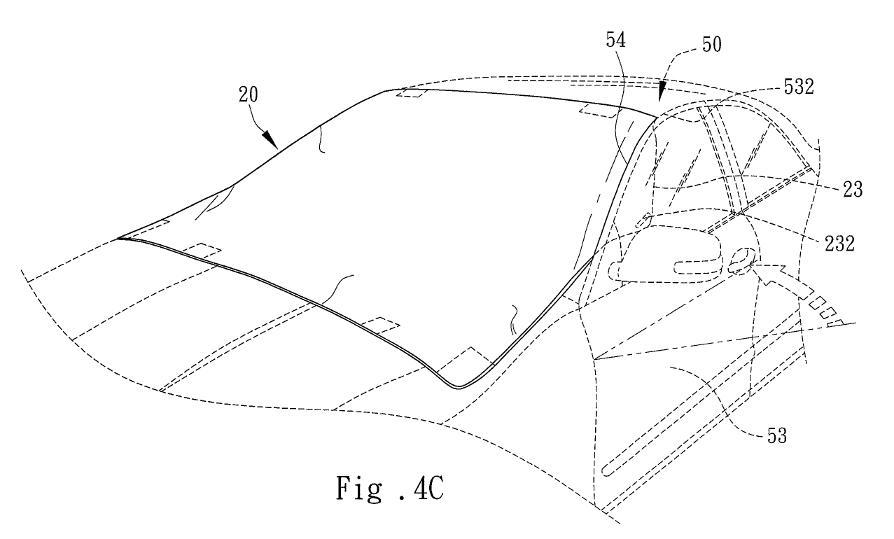

When in use, referring to FIG. 4A, first, anchor the fastening elements 22 at the upper end of the main shade 21 on a car roof 51 of an automobile 50, and also anchor the other fastening elements 22 at the lower end of the main shade 21 on a car hood 52. The pendants 232 on the flaps 23 stretch the main shade 21 smoothly from the left side and right side along car windows 531 at two sides. When a car door 53 is opened at a sufficient width, referring to FIG. 4B, the pendant 232 slides on the arched car window 531 and drops inside the car door 53. Referring to FIG. 4C, after the pendant 232 slid in the car behind the car door 53, the car door 53 can be closed to hold the pendent self-stretched flaps 23 inside the automobile 50. The automobile 50 and an upper edge 532 of the car door 53 clamp the pendent self-stretched flap 23 securely so that the snow cover 20 can neatly cover the windshield. Moreover, as the pendant 232 is formed at a greater size than a crevice 54 formed between the closed upper edge 532 and the automobile 50, a theft-proofing effect also can be accomplished.

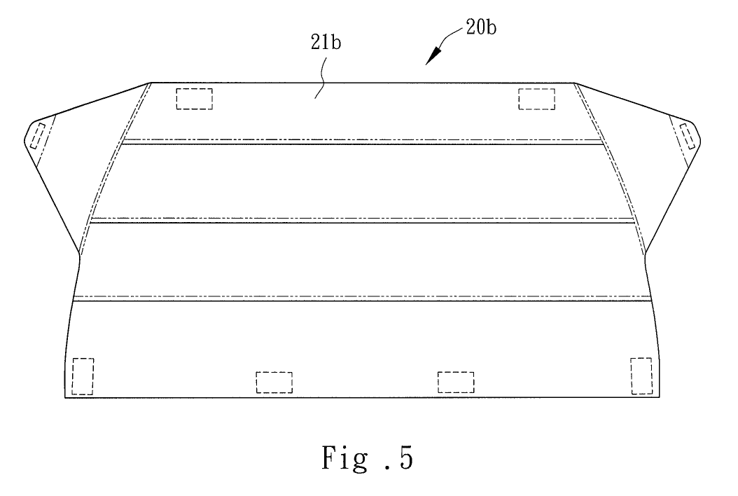

Refer to FIG. 5 for another embodiment of the invention. The main shade 21b of the snow cover 20b may also be formed by stacking a plurality of sheets together from a lower side to an upper side. Such a structure has a front surface allowing accumulated snow to slide away quickly. The sheets are fastened at junctions at the back side that elevate the main shade 21b slightly higher, thus can prevent the snow cover 20b from sticking to the windshield due to moisture and temperature that might otherwise cause removing difficult.

Also referring to FIG. 3, the corner 231 of the pendent self-stretched flap 23 can be stuffed with pliable filler, or the pendant 232 may be covered by a pliable material to avoid scratching the car window 531 (not shown in the drawings).

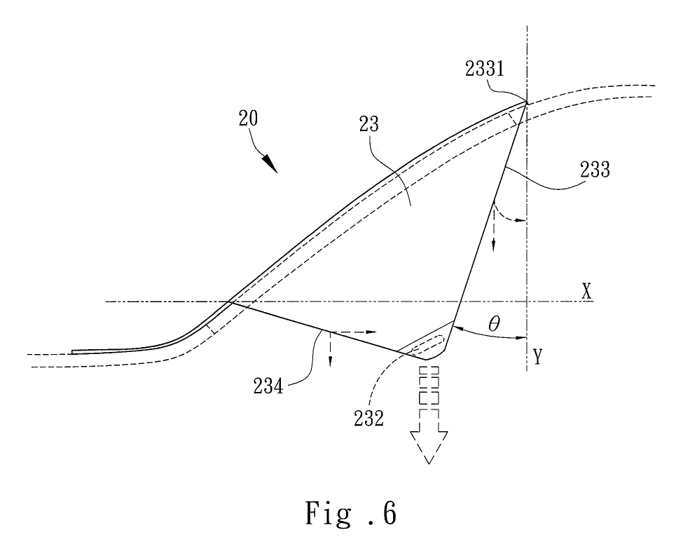

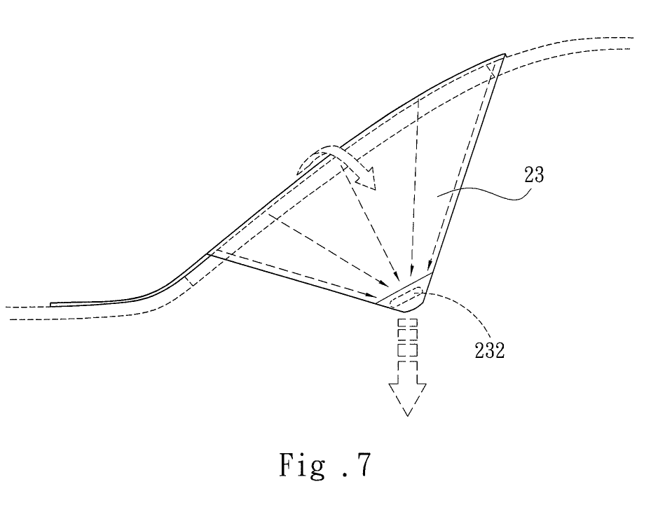

Refer to FIG. 6 for the principle of the invention. After installation, the pendent self-stretched flap 23 has a first force receiving side 233 forming an angle θ tilted towards the main shade 21 against a perpendicular line leading to a first force receiving end 2331 of the flap 23. The angle θ also is formed to mate a second force receiving side 234 and a second force receiving end 2341 of the pendent self-stretched flap 23. The first force receiving end 2331 and the second force receiving end 2341 are the most effective stretching spots of the main shade 21. The pendant 232 drags the first force receiving side 233 downwards to form the angle θ with the perpendicular line. The second force receiving side 234 also is stretched by the pendant 232 and the first force receiving side 233 at the angle θ so that the pendent self-stretched flap 23 is stretched in a shape shown in FIG. 7. Under the stretching force provided by the pendant 232, the main shade 21 can be stretched smoothly towards two ends.

Referring to FIGS. 4B and 7, during the car doors 53 are open, two pendants 232 and pendent self-stretched flaps 23 slide along the car doors 53 into the automobile. Hence installation can be done quickly. Open the car doors 53, the snow cover also can be removed quickly.

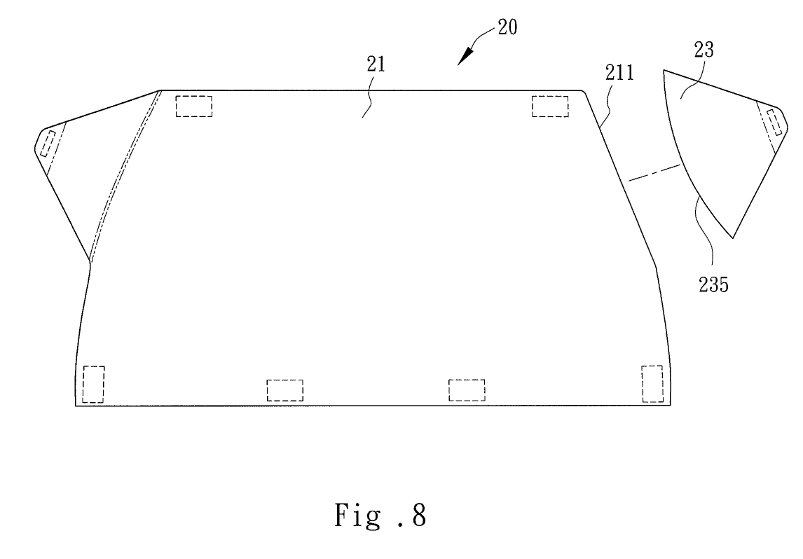

Referring to FIG. 8, for fabrication of the invention, the main shade 21 may have two fastening ends 211 formed in straight lines. The pendent self-stretched flap 23 is triangular and formed in a fan shape with an arched side 235 fastening to each fastening end 211. The snow cover 20 thus formed can neatly cover the curved surface of the car body when in use.

As a conclusion, the invention provides a triangular pendent self-retracted flap fastened to a pendant, and can effectively stretch the main shade with a minimum size of the pendent self-stretched flap and a single pendant. The pendent self-stretched flaps at two sides are evenly stretched by the pendants, so that when the car doors are closed, the main shade can fully cover the windshield to fend off snow and provide effective protection. It provides multiple functions, and can be installed and removed quickly and also is theft-proof.

What is claimed is:

1. A fast installable and detachable automobile snow cover having two pendent self-stretched flaps, comprising:
a main shade;
a plurality of fastening elements located on an upper end and a lower end of the main shade;
two pendent self-stretched flaps formed respectively in triangular and located at a left side and a right side on an upper portion of the main shade; and
two pendants located respectively on a corner of two pendent self-stretched flaps;
wherein the fastening elements at the upper end of the main shade are anchorable on a car roof and the fastening elements at the lower end are anchorable on a car hood; each pendent self-retracted flap having a first force receiving side to form an angle θ tilted towards the main shade against a perpendicular line leading to a first force receiving end of the flap such that two pendent self-retracted flaps stretch the main shade, and two pendent self-retracted flaps and the pendants slide along an upper edge of opening car doors inside the car doors, and two pendent self-retracted flaps are clamped by a crevice formed between an upper edge of the car doors and a car body after the car doors are closed.

2. The fast installable and detachable automobile snow cover of claim 1, wherein the main shade has a lower side wider than an upper side thereof.

3. The fast installable and detachable automobile snow cover of claim 1, wherein the main shade is formed by stacking a plurality of sheets from the lower side to the upper side.

4. The fast installable and detachable automobile snow cover of claim 1, wherein the fastening elements are magnetic slats.

5. The fast installable and detachable automobile snow cover of claim 1, wherein the pendants are formed at a size greater than the crevice between the upper edge of the car door and the car body.

6. The fast installable and detachable automobile snow cover of claim 1, wherein the pendants are covered by a pliable material.

7. The fast installable and detachable automobile snow cover of claim 1, wherein each pendent self-retracted flap has a second force receiving side formed at a selected length and a second force receiving end formed at a selected location to mate the angle θ.
